(19) United States
(12) Patent Application Publication
(10) Pub. No.: US 2026/0277573 A1
(43) Pub. Date: Sep. 17, 2026

(54) AUTOMATED QUALITY EVALUATION IN COMPLIANCE POLICY GENERATION

(71) Applicant: INTERNATIONAL BUSINESS MACHINES CORPORATION, ARMONK, NY (US)

(72) Inventors: YUJI WATANABE, Kawasaki-shi (JP); HIROKUNI KITAHARA, Sumida-ku (JP); Saki TAKANO, Tokyo (JP); RURIKO HAMADA, Saitama-shi (JP)

(21) Appl. No.: 19/080,977

(22) Filed: Mar. 17, 2025

(51) Int. Cl. G06F 8/41

(52) U.S. Cl. CPC G06F 8/427

(57) ABSTRACT

A method, computer system, and a computer program product are provided for generating a description from synthetic data by obtaining inferred code and data to determine accuracy. The inferred code is parsed to determine an inferred code template and an inferred description template. A plurality of code template sets is then obtained and compared it to the inferred code template. It is then determined as when any of said code template sets are a close match to content of the inferred code template. A plurality of seeds is then extracted from the inferred code template and any of the code template sets that were determined to be a close match to the inferred code template. A description template corresponding is obtained, and a new description is then generated from synthetic data using said plurality of seeds and said corresponding description template.

### BACKGROUND

The present invention relates generally to the field of machine learning and more particularly to quality evaluation in compliance policy generation associated with large language models (LLMs).

Large language models (LLMs) are a category of foundation models trained on immense amounts of data. They are trained so as to make them capable of understanding and generating natural language and other types of content to perform a wide range of tasks. LLMs are redefining an increasing number of business processes and have proven their versatility across a myriad of use cases and tasks in various industries.

LLMs stand to impact every industry, from finance to insurance, human resources to healthcare and beyond. LLMs can be used in text generation, content summarization, Artificial Intelligence assistance, code generation and error recovery, uncovering security issues in multiple programming. However, Organizations need a solid foundation in governance practices to harness the potential of AI models to revolutionize the way they do business. This means providing access to AI tools and technology that is trustworthy, transparent, responsible, and secure. LLMs can be used to also enable compliance checks more effectively and in line with compliance policies. Unfortunately, most policy languages are declarative languages and code that are less flexible to write. They are also difficult to evaluate from a user input evaluation.

### SUMMARY

Embodiments of the present invention disclose a method, computer system, and a computer program product for generating description from synthetic data by obtaining inferred code and data to determine accuracy of a description previously generated by synthetic data. The inferred code is parsed to determine an inferred code template and an inferred description template. A plurality of code template sets are then obtained and compared it to the inferred code template. It is then determined as when any of said code template sets are a close match to content of the inferred code template. A plurality of seeds is then extracted from the inferred code template and any of the code template sets that were determined to be a close match to the inferred code template. A corresponding description template corresponding is obtained to the identified code template set determined to be a close match to said inferred code template. A new description is then generated from synthetic data using said plurality of seeds and said corresponding description template.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to at least one embodiment;

FIG. 2 provides an operational flowchart for a synthetic data generation technique, according to one embodiment;

FIG. 3 provides an operational flowchart of an alternate synthetic data generation technique, according to one embodiment; and

FIG. 4 is a graphical depiction of an embodiment and an example of a graph showing evaluation as per proposed approach.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

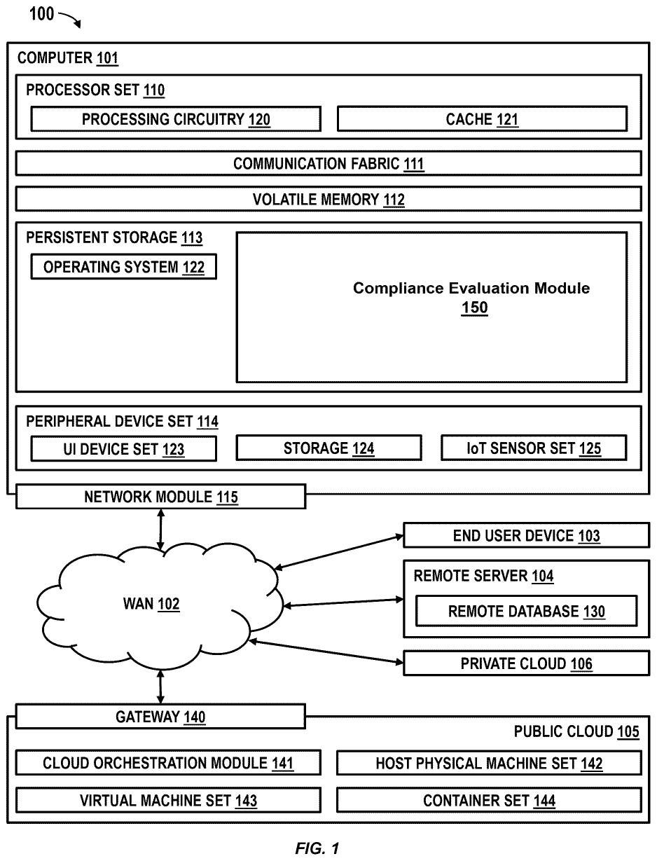

FIG. 1 provides a block diagram of a computing environment 100. The computing environment 100 contains an example of an environment for the execution of at least some of the computer code involved in performing the inventive methods, such as code change differentiator which is capable of providing a multi-cloud compliance evaluation module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

LLMs stand to impact every industry, from finance to insurance, human resources to healthcare and beyond. LLMs can be used in text generation, content summarization, Artificial Intelligence assistance, code generation and error recovery, uncovering security issues in multiple programming. However, Organizations need a solid foundation in governance practices to harness the potential of AI models to revolutionize the way they do business. This means providing access to AI tools and technology that is trustworthy, transparent, responsible, and secure. LLMs are used to generate compliance policy and ensure adherence to them to provide security and transparency. Traditionally, many policy languages used by LLMs in this regard are declarative languages (i.e., Ansible Rulebook and Kubernetes manifest).

LLM can be trained to distinguish data. In terms of training LLM, synthetic data can be used as training data. Since declarative code is less flexible to write, synthetic data can be generated by using templates of code and description. On the other hand, there is a problem that it is difficult to evaluate the code generated from user input because there is no ground truth. Syntax check by using linter or code formatter cannot check the generated code is semantically correct. Therefore, tests are needed that require various inputs from users to prepare a set of input data.

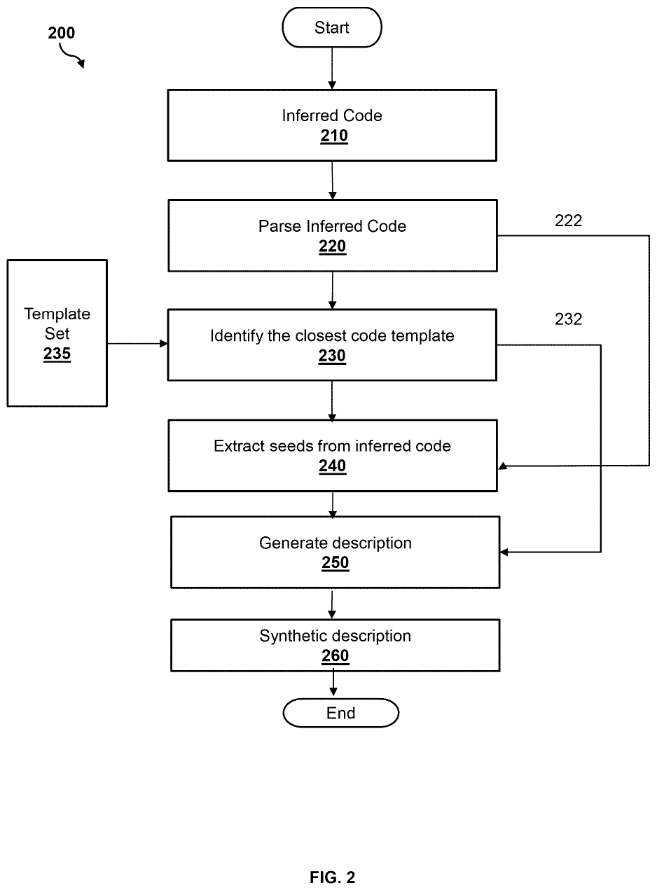

To overcome these challenges of the prior art, FIG. 2 provides a process 200 that provides a synthetic reverse generation of description from code by utilizing a template matching system. This allows to provide, from an inferred code and template set for synthetic data generation, to identify the closest code template, and extract seeds from code (seeds is an initial data or values to create code). By using the description template corresponding to the identified code template and extracted seeds, generate description from inferred code.

Process 200 also provides techniques for the evaluation of generated code by using similarity without requiring any ground truth. This is done in one embodiment by evaluating the inferred code based on the similarity between original description and generated description. In one case, when the generated description is much longer than the original description, the generated description is summarized to reduce the length. Subsequently, the similarity between the original description and the summarized generated description is calculated.

In Step 210, the inferred code is obtained or submitted to be parsed in Step 220. An example of an inferred code for synthetic description generation is provided below. It is an example capturing an embodiment using ansible rulebook.

| | |
|---|---|
| - | name: Hello Events |
| | hosts: local host |
| | sources: |

| - | Ansible.eda.webhook: |
|---|---|
| | host:0.0.0.0 |
| | port: 5000 |
| rules: | |
| - | name: say Hello |
| | condition: even.payload.message = = “sakana” |
| | action: |
| | run_playbook: |
| | name: test_palybook.ymlfun |

Synthetic data for declarative code can be generated by using templates of each code block as seen at 222. Using the above example using an ansible rulebook, the code block 222 (Matched code_template) may be (AST of source block) something to the example below:

```
“sources” : [
{
    “EventSource”: {
        “name”: “ansible.eda.webhook”,
        “source_args”: {
          “host”: “0.0.0.0”,
          “port” : 5000
      }
  }
  }
```

Additional template sets for the code can be provided as shown at 235. Using the above example, the template Set may be something like:
Template=(code_template, desc_template)

Each template contains at least a code template and a description template. Any closest code template is then determined as in Step 230 and any closed templates can be provided to extract seeds from the inferred code as provided in Step 240. Alternatively exact matched code templates 232 (Matched desc_template) are provided to Step 250 as shown. Again, referencing the above example, the matched code could be:

| Matched code_template: | |
|---|---|
| Code: l | |
| - | name : receive events from webhook |
| | ansible.eda.webhook: |
| | host: $host_name |
| | port : $port_number |
| Matched desc_template: | |
| description: | |
| - | from webhook on host $host_name and port $port_number |
| - | from webhook on host $host_name:$port_number |

Synthetic code data is generated from code templates and seeds (Step 230 and 240) as provided in Step 250. Similarly, the description of the synthetic code data is generated from the description template and seeds as well in this step (there are template1 to templateN to cover the syntax of the code). In this example, an extracted seed could be something like host_name: “0.0.0.0” with a Port: 5000.

In one embodiment, the synthetic code generation of process 200 is provided by parsing the generated code and creating an abstract syntax tree (AST)—Step 210 and 220. The LLM can also generate the code from user input. The code blocks from AST and as identified from the closest code template are (Step 230) provided to each code. The seeds are extracted from the code template (Step 240) and generated code is provided (Step 250). The general description from the extracted seeds and the description templates corresponding to the identified code templates are used to generate the new description and synthetic data in Step 260.

Using the same example above, a generated synthetic description from the code could be:

```
[
  “from webhook on host 0.0.0.0 and port 5000”,
  “from webhook on 0.0.0.0:5000”
  ]
```

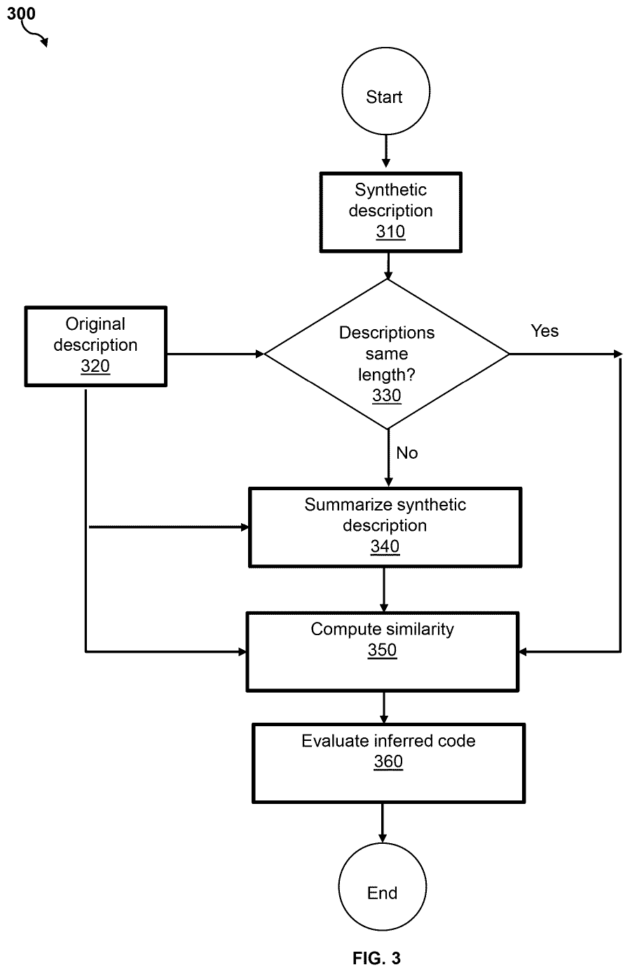

FIG. 3 provides flow diagram as per one embodiment providing a process 300 that is similar to process 200 of FIG. 2. Process 300 provides a technique for evaluation of the generated code quality based on the similarity of syntax and check results. This step was incorporated into FIG. 2 through process 200, but a more detailed view can be provided herein.

In Step 310, the syntax description is provided to assess similarity between and original description and a generated description. The original description is provided at Step 320. The decision block/Step 330 code. If the code is substantially similar (one example is if the descriptions the same length but alternate embodiments can be provided), the decision block forwards the process to Step 350 for the similarities to be computed. Otherwise, when the decision block does not find sufficient similarities the process of computing the similarity is performed as in Step 340. This can include summarizing the generated description to the same length as original and computing similarity between original and summarized description (more in Step 350). Step 340 summarizes the synthetic description.

In Step 360, the inferred code is evaluated. The evaluation, in one embodiment, can include evaluating the generated code quality based on the similarity and syntax heck results.

Process 200 and 300 of FIGS. 2 and 3 provide many advantages over the prior art. For example, they provide for an end-to-end, continuous compliance that introduces an efficient way to implement policies with minimal manual efforts. This allows the LLMs to generate compliance policy much easier. When using LLM for generating compliance policy, the processes 200/300 ensure that the quality is maintained. This is crucial even without needing the ground truth. In addition, the processes enable automated quality evaluation of declarative code generated by LLM. In one embodiment, this can be used for a variety of declarative languages (e.g., Ansible Policybook, Rulebook, Kyverno and OPA Rego.)

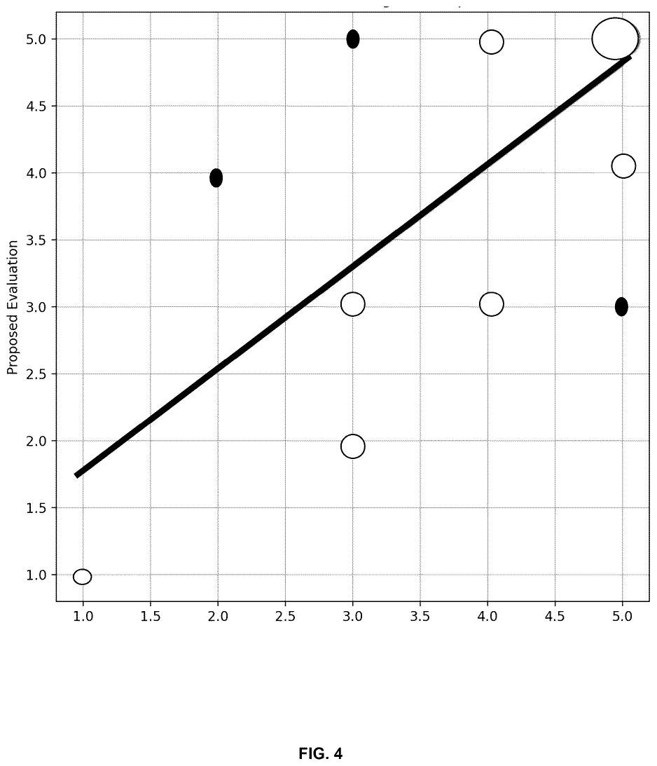

FIG. 4 is a graphical depiction of an embodiment and an example of a graph showing evaluation as per proposed approach. The regression line 400 of the graph shows that the evaluation by proposed approach does not significantly differ from that of persons familiar with rulebook.

In this graphical example, the graph shows correlation of quality scores by human and proposed approach. The following determinations can be made by examining this graph:
Test data: Ansible rulebook
Number of Samples: 27
Score 5 indicates good quality
Score 1 indicates low quality
Blue represents no score gap or score gap=1
Orange represents score gap>=2
Circle Size Represents the Amount of Data

The process 200 and 300 as discussed above provides many advantages. For one, it is important for end-to-end continuous compliance to provide an efficient way to implement policies with minimal manual efforts. Therefore, it is good to use Large Language Model (LLM) for generating compliance policy. In addition, when using LLM for generating compliance policy, ensuring quality is crucial even without ground truth. Process 200/300 enables automated quality evaluation of declarative code generated by LLM. It can also be used for declarative languages such as Ansible Policybook, Rulebook, Kyverno and OPA Rego.

In this manner, as per embodiments of process 200 and 300, techniques are provided generating a description from synthetic data that may be used by large language (LLM). In one embodiment, the inferred code or submitted code and data are used to determine accuracy of a description previously generated by a synthetic data stream. This is performed by parsing the inferred code to determine an inferred code template and an inferred description template. A plurality of template sets are then obtained and compared to the inferred code template to determine when any of said plurality of code template sets are a close match to content of the inferred code template. Thereafter a plurality of seeds are extracted from the inferred code template and any of the code template sets that were determined to be a close match to the inferred code template. A corresponding description template is obtained that corresponds to any of the code template sets determined to be a close match to the inferred code template. Thereafter a new description is generated from said synthetic data stream using said plurality of seeds and the corresponding description template.

In one embodiment, the new description generated is compared to the inferred description template and determined if it is longer than the latter. In that case, a summary description of the new description is generated to reduce length of said new description and the summary os substituted as the new description. In addition, in one embodiment a similarity amount (can be a value or percentage etc.) is calculated between the inferred code and the summary description of the new description generated. An evaluation of the summary description can also be evaluated based on the degree (amount) of similarity calculated.

In one embodiment, the inferred code can also be parsed to create an AST from the inferred code (parsed). The AST is used to obtain a plurality of code blocks to identify one or more matching code templates.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating description from synthetic data used by large language (LLM), comprising:
obtaining inferred code and data to determine accuracy of a description previously generated by a synthetic data stream;
parsing inferred code to determine an inferred code template and an inferred description template;
obtaining a plurality of code template sets and compare it to said inferred code template;
determining when any of said plurality of code template sets are a close match to content of said inferred code template;
extracting a plurality of seeds from said inferred code template and any of said code template sets that were determined to be a close match to said inferred code template;
obtaining a corresponding description template corresponding to said any of said code template sets determined to be a close match to said inferred code template; and
generating a new description from said synthetic data stream using said plurality of seeds and said corresponding description template.

2. The method of claim 1, further comprising:
compare said new description generated with said inferred description template;
determine when said new description generated is longer than said inferred description template;
provide a summary description of said new description generated to reduce length of said new description generated; and
substitute said summary description as said new description generated.

3. The method of claim 2, further comprising:
calculating an amount of similarity between said inferred code and said summary description of said new description generated.

4. The method of claim 3, further comprising generating an evaluation of said summary description based on said amount of similarity calculated.

5. The method of claim 1, further comprising:
parsing said inferred code;
creating an abstract syntax tree (AST) from said inferred code parsed; and
using said AST obtain a plurality of code blocks to identify one or more matching code templates.

6. The method of claim 1, wherein said plurality of template set comprises template1 to templateN.

7. The method of claim 1 wherein LLM generates the code from user input.

8. A system for generating description from synthetic data used by large language (LLM), comprising:
one or more computers with executable instructions that when executed cause the system to:
obtain inferred code and data to determine accuracy of a description previously generated by a synthetic data stream;
parse inferred code to determine an inferred code template and an inferred description template;
obtain a plurality of code template sets and compare it to said inferred code template;
determine when any of said plurality of code template sets are a close match to content of said inferred code template;
extract a plurality of seeds from said inferred code template and any of said code template sets that were determined to be a close match to said inferred code template;
obtain a corresponding description template corresponding to said any of said code template sets determined to be a close match to said inferred code template; and
generate a new description from said synthetic data stream using said plurality of seeds and said corresponding description template.

9. The computer system of claim 8, further comprising:
compare said new description generated with said inferred description template;
determine when said new description generated is longer than said inferred description template;
provide a summary description of said new description generated to reduce length of said new description generated; and
substitute said summary description as said new description generated.

10. The computer system of claim 9, further comprising:
calculate an amount of similarity between said inferred code and said summary description of said new description generated.

11. The computer system of claim 10, further comprising:
generate an evaluation of said summary description based on said amount of similarity calculated.

12. The computer system of claim 8, further comprising:
parse said inferred code;
create an abstract syntax tree (AST) from said inferred code parsed; and
use said AST obtain a plurality of code blocks to identify one or more matching code templates.

13. The computer system of claim 8, wherein said plurality of template set comprises template1 to templateN.

14. The computer system of claim 8, wherein LLM generates a code from user input.

15. A computer program product for generating description from synthetic data used by large language (LLM), comprising
one or more computer readable storage media;
program instructions, stored on at least one of the one or more storage media for execution by at least one of the one or more processors via at least one of the one or more memories, to:
obtain inferred code and data to determine accuracy of a description previously generated by a synthetic data stream;
parse inferred code to determine an inferred code template and an inferred description template;
obtain a plurality of code template sets and compare it to said inferred code template;
determine when any of said plurality of code template sets are a close match to content of said inferred code template;
extract a plurality of seeds from said inferred code template and any of said code template sets that were determined to be a close match to said inferred code template;
obtain a corresponding description template corresponding to said any of said code template sets determined to be a close match to said inferred code template; and
generate a new description from said synthetic data stream using said plurality of seeds and said corresponding description template.

16. The computer program product of claim 15, further comprising:
compare said new description generated with said inferred description template;
determine when said new description generated is longer than said inferred description template;
provide a summary description of said new description generated to reduce length of said new description generated; and
substitute said summary description as said new description generated.

17. The computer program product of claim 16, further comprising:
calculate an amount of similarity between said inferred code and said summary description of said new description generated.

18. The computer program product of claim 17, further comprising:
generate an evaluation of said summary description based on said amount of similarity calculated.

19. The computer program product of claim 15, further comprising:
parse said inferred code;
create an abstract syntax tree (AST) from said inferred code parsed; and
use said AST obtain a plurality of code blocks to identify one or more matching code templates.

20. The computer program product of claim 15, wherein said plurality of template set comprises template1 to templateN; and wherein LLM generates the code from user input.
